(19) United States
(12) Patent Application Publication
(10) Pub. No.: US 2026/0057167 A1
(43) Pub. Date: Feb. 26, 2026

(54) PAGE ELEMENT DETECTION

(71) Applicant: Beijing Youzhuju Network Technology Co., Ltd., Beijing (CN)

(72) Inventors: Jialong Zeng, Beijing (CN); Chenghao Yao, Beijing (CN); Hao Zhang, Beijing (CN); Bin Hu, Beijing (CN); Hexiang Zeng, Beijing (CN)

(21) Appl. No.: 18/983,900

(22) Filed: Dec. 17, 2024

(30) Foreign Application Priority Data
Aug. 23, 2024 (CN) 202411170827.7

(51) Int. Cl. G06F 40/14; G06F 40/194

(52) U.S. Cl. CPC G06F 40/14; G06F 40/194

(57) ABSTRACT

The disclosure provides a method, apparatus, device, storage medium and product of page element detection. The method includes: obtaining first element attribute information of a target page element presented in a viewport of a predetermined page at a first moment, and obtaining second element attribute information of the target page element at a second moment, the second element attribute information and the first element attribute information being element attribute information of a same predetermined element attribute, and a difference between the second moment and the first moment is less than a predetermined duration; and in accordance with a determination that a numerical difference between the first attribute information and the second attribute information is greater than a predetermined numerical difference threshold, determining that abnormal presentation is present for the target page element. With the above solutions, the page element detection accuracy can be improved.

### CROSS-REFERENCE

The present application claims priority to Chinese Patent Application No. 202411170827.7, filed on Aug. 23, 2024, and entitled “METHOD, APPARATUS, DEVICE, STORAGE MEDIUM AND PRODUCT OF PAGE ELEMENT DETECTION”, the entirety of which is incorporated herein by reference.

### FIELD

The embodiment of the present disclosure relates to the technical field of computers, in particular to page element detection.

### BACKGROUND

With the rapid development of Internet technologies and terminal technologies, information that can be carried in a webpage or an application page is becoming increasingly rich.

In a page, there are usually multiple page elements, and the rendering order and stability of the page elements in the page directly affect the page presentation effect and the experience when the user views the page. However, due to network delay or resource loading, an abnormal jumping change may occur in the presentation of the page elements. At present, front-end performance detection tools mostly focus on detection and analysis of overall performance such as page loading time, resource usage and rendering speed, and it is difficult to accurately detect the jumping change abnormality.

### SUMMARY

Embodiments in the present disclosure provide a method, apparatus, device, storage medium and product of page element detection, and can optimize the existing page element detection solutions.

According to a first aspect, embodiments of the present disclosure provide a method of page element detection, comprising: obtaining first element attribute information of a target page element presented in a viewport of a predetermined page at a first moment; obtaining second element attribute information of the target page element at a second moment, wherein the second element attribute information and the first element attribute information are element attribute information of a same predetermined element attribute, and a difference between the second moment and the first moment is less than a predetermined duration; and in accordance with a determination that a numerical difference between the first attribute information and the second attribute information is greater than a predetermined numerical difference threshold, determining that abnormal presentation is present for the target page element.

According to a second aspect, embodiments of the present disclosure further provide an apparatus of page element detection, comprising: a first attribute information obtaining module, configured to obtain first element attribute information of a target page element presented in a viewport of a predetermined page at a first moment; a second attribute information obtaining module, configured to obtain second element attribute information of the target page element at a second moment, wherein the second element attribute information and the first element attribute information are element attribute information of a same predetermined element attribute, and a difference between the second moment and the first moment is less than a predetermined duration; and an abnormality detection module, configured to in accordance with a determination that a numerical difference between the first attribute information and the second attribute information is greater than a predetermined numerical difference threshold, determine that abnormal presentation is present for the target page element.

According to a third aspect, embodiments of the present disclosure further provide an electronic device, comprising: one or more processors; a storage device, storing one or more programs, the one or more programs, when are executed by the one or more processors, causing the one or more processors to implement the method of page element detection provided in the embodiments of the present disclosure.

According to a fourth aspect, embodiments of the present disclosure further provides a storage medium comprising computer-executable instructions, wherein the computer-executable instructions, when executed by a computer processor, perform the method of page element detection provided in the embodiments of the present disclosure.

According to a fifth aspect, embodiments of the present disclosure further provide a computer program product, comprising a computer program, the computer program, when executed by a processor, implementing the method of page element detection provided in the embodiments of the present disclosure.

The page element detection solution provided by the embodiments of the present disclosure including: obtaining first element attribute information of a target page element presented in a viewport of a predetermined page at a first moment, and obtaining second element attribute information of the target page element at a second moment, wherein the second element attribute information and the first element attribute information are element attribute information of a same predetermined element attribute, and a difference between the second moment and the first moment is less than a predetermined duration, and in accordance with a determination that a numerical difference between the first attribute information and the second attribute information is greater than a predetermined numerical difference threshold, determining that abnormal presentation is present for the target page element. By adopting the above solution, the attribute information of the same predetermined element attribute at different moments is obtained for the page element presented in the viewport, and if the element attribute information changes greatly in a relatively short time, then abnormal conditions such as the presentation jumping change of the page element can be determined, and the accuracy of page element detection is improved.

### BRIEF DESCRIPTION OF DRAWINGS

The above and other features, advantages, and aspects of various embodiments of the present disclosure will become more apparent from the following detailed description taken in conjunction with the accompanying drawings. Throughout the drawings, the same or similar reference numbers refer to the same or similar elements. It should be understood that the drawings are schematic, and elements and elements are not necessarily drawn to scale.

FIG. 1 is a schematic flowchart of a method of page element detection according to embodiments of the present disclosure;

FIG. 2 is a schematic flowchart of a method of page element detection according to embodiments of the present disclosure;

FIG. 3 is a schematic structural diagram of an apparatus of page element detection according to embodiments of the present disclosure;

FIG. 4 is a schematic structural diagram of an electronic device according to embodiments of the present disclosure.

### DETAILED DESCRIPTION

Embodiments of the present disclosure will be described in more detail below with reference to the accompanying drawings. While certain embodiments of the present disclosure are shown in the drawings, it is to be understood that the present disclosure may be implemented in various forms, and should not be construed as limited to the embodiments set forth herein, and vice versa. It should be understood that the drawings and embodiments of the present disclosure are for exemplary purposes only and are not intended to limit the scope of the present disclosure.

It should be understood that the steps recited in the method embodiments of the present disclosure may be performed in different orders, and/or in parallel. Further, the method embodiments may include additional steps and/or omit performing the illustrated steps. The scope of the present disclosure is not limited in this respect.

As used herein, the term “comprising” and variations thereof are open-ended, i.e., “including but not limited to”. The term “based on” is “based at least in part on”. The term “one embodiment” means “at least one embodiment”; the term “another embodiment” means “at least one further embodiment”; the term “some embodiments” means “at least some embodiments”. The relevant definitions of other terms will be given below.

It should be noted that the concepts such as “first” and “second” mentioned in this disclosure are merely used to distinguish different apparatuses, modules, or units, and are not intended to limit the order of functions performed by the apparatuses, modules, or units or the mutual dependency relationship.

It should be noted that the modification of “a” and “a plurality” mentioned in this disclosure is illustrative and not limiting, and those skilled in the art should understand that “one or more” should be understood unless the context clearly indicates otherwise.

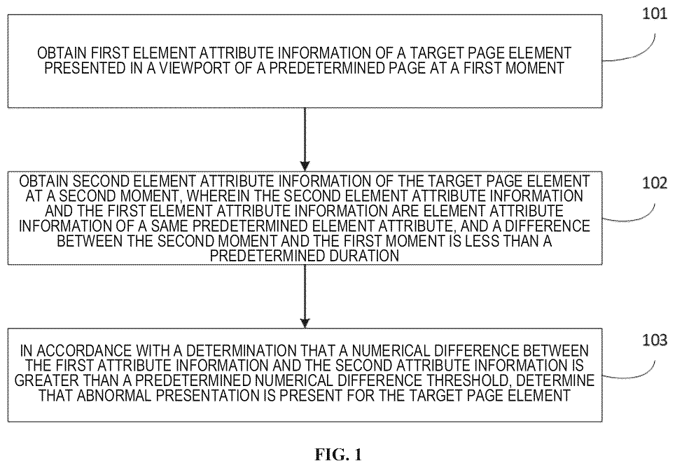

FIG. 1 is a schematic flowchart of a page element detection process according to embodiments of the present disclosure, and the embodiments of the present disclosure are applicable to a case of detecting whether a page element in a viewport of a page shows a jumping change presentation condition. The method may be performed by an apparatus of page element detection, and the apparatus may be implemented in a form of software and/or hardware, optionally, implemented by an electronic device, and the electronic device may be a mobile terminal such as a mobile phone, a smart watch, a tablet computer, and a personal digital assistant, or may be a personal computer (PC) terminal or a server.

As shown in FIG. 1, the method comprises the following steps.

Step 101: first element attribute information of a target page element presented in a viewport of a predetermined page at a first moment is obtained.

For example, the page in the embodiments of the present disclosure may be an application page or a webpage corresponding to a predetermined client, which is not specifically limited. The predetermined client may be a client running in the electronic device, such as a predetermined application, or a webpage client. The predetermined page may be any page or a specified page in the predetermined client.

In the embodiments of the present disclosure, the viewport may be understood as a region where the predetermined client presents the page content, and the viewport usually matches the screen of the electronic device. The predetermined page may be divided into an in-viewport and an out-viewport, the in-viewport refers to a part that the user may see, and the out-viewport refers to a part that is not visible to the user. Due to the limitation of the screen size of the electronic device, one page may not be completely presented in the screen, the portion presented in the screen is referred to as the in-viewport, and a portion presented outside the screen is referred to as the out-viewport. Based on this, the page elements in the page may be classified into a page element in the viewport and a page element outside the viewport, and the user may browse the page element outside the viewport by triggering scrolling, page turning, or tab switching on the predetermined page.

For example, the predetermined page corresponds to a predetermined element set, the predetermined element set comprises a presentable page element of the predetermined page, the presentable page element is a page element that may be presented in the predetermined page. At a same moment, there is a presentable page element that is currently presented in the viewport (a page element in the viewport) and a presentable page element that is not presented in the viewport (a page element outside the viewport). Optionally, the presentable page element may specifically be a presentable page element of a predetermined type, and the predetermined type is, for example, a type presented in a predetermined form. The predetermined form may be, for example, a card, and the predetermined element set may comprise a presentable card of the predetermined page. In a specific application scenario, for example, an e-commerce scenario, the predetermined page may be a store page, a commodity list page, an order page, or a shopping cart page, and the predetermined element set included in the corresponding predetermined page may comprise a store card, event card, or product card, etc.

For example, the first moment may be any moment when the predetermined page is in the presentation state. At the first moment, a presentable page element (or a presentable page element of a predetermined type) presented in the viewport of the predetermined page is denoted as a target page element.

For example, the element attribute information may be an attribute value of a predetermined element attribute, and the predetermined element attribute may comprise, for example, at least one of an element position, an element size, an element background color, or an element state (for example, a selection state or a trigger state). The element attribute information of the target page element at the first moment is denoted as the first element attribute information.

Step 102: second element attribute information of the target page element at a second moment is obtained, wherein the second element attribute information and the first element attribute information are element attribute information of a same predetermined element attribute, and a difference between the second moment and the first moment is less than a predetermined duration.

For example, the second moment is a moment after the first moment, and a difference between the second moment and the first moment is less than a predetermined duration, that is, the second moment is close to the first moment. The element attribute information of the target page element at the second moment is denoted as the second element attribute information. The second element attribute information and the first element attribute information are element attribute information of a same predetermined element attribute. For example, if the first element attribute information is an element position value, the second element attribute information is also an element position value.

Optionally, the first moment is a moment before a predetermined event is triggered, and the second moment is a moment after the predetermined event is triggered; and the predetermined event comprises at least one of: a page refresh event, an event of invoking a page data request interface or a page interaction event. Therefore, it may be detected whether abnormal presentation is present for the target page element before and after the predetermined event is triggered.

The page refresh event may be triggered automatically by the predetermined client or triggered by a user operation, and it may be detected whether abnormal presentation is present for the target page element in the viewport before and after the page refresh. If page data needs to be reobtained, page data obtaining may be performed in a manner of invoking a corresponding interface, and it may be detected whether abnormal presentation is present for the target page element in the viewport before and after the page data obtaining. The page interaction event may be that a user inputs an interaction operation based on the predetermined page, and the specific type of the interaction operation is not limited, which may be related to an actual application scenario, for example, the foregoing example e-commerce scenario. The user may modify the number of commodities that need to be purchased through the manner of triggering the control, for example, the number is increased by 1, and it may be detected whether abnormal presentation is present for the target page element in the viewport before and after the control is triggered.

Step 103: in accordance with a determination that a numerical difference between the first attribute information and the second attribute information is greater than a predetermined numerical difference threshold, it is determined that abnormal presentation is present for the target page element.

For example, if the number of predetermined element attributes is 1, the difference between the attribute value in the first attribute information and the attribute value in the second attribute information may be directly computed as a numerical difference, and the numerical difference is compared with a predetermined numerical difference threshold. If there are a plurality of predetermined element attributes, a difference corresponding to each predetermined element attribute between an attribute value in the first attribute information and an attribute value in the second attribute information may be separately computed, and then a numerical difference is determined according to the plurality of differences. The determined numerical difference may be a numerical value and is used to be compared with a predetermined numerical difference threshold. The determined numerical difference may also be a plurality of numerical values (for example, each numerical value corresponds to a difference), and each numerical value is respectively compared with a predetermined numerical difference threshold corresponding to a predetermined element attribute (that is, there may exist a plurality of the predetermined numerical difference thresholds with an one-to-one correspondence with predetermined element attributes). If at least one comparison result is that the value is greater than the threshold, or all results are that the values are greater than the corresponding thresholds, it is determined that the numerical difference between the first attribute information and the second attribute information is greater than the predetermined numerical difference threshold.

For example, if the numerical difference between the first attribute information and the second attribute information is greater than the predetermined numerical difference threshold, it may be indicated that the target page element presented in the viewport at the first moment has changed dramatically in a short time, and it may be determined that abnormal conditions such as presentation jumping change of the page element are present.

As in the above example, it is assumed that the predetermined element set includes 100 commodity cards, and 6 commodity cards are presented most simultaneously in the viewport. Assuming that the target page elements at the first moment comprise 6 commodity cards, where the position of one commodity card (denoted as commodity card a) is 1, and after the page is refreshed, at the second moment, the position of the commodity card a becomes 100, then the position of the commodity card a has a jumping change. If the predetermined numerical difference threshold is 10, the detection result of the jumping change abnormality may be determined by judging whether 99 is greater than 10.

Optionally, in accordance with a determination that the numerical difference between the first attribute information and the second attribute information is less than or equal to a predetermined numerical difference threshold, it is determined that normal presentation is present for the target page element.

According to the method of page element detection provided by the embodiments of the present disclosure, first element attribute information of a target page element presented in a viewport of a predetermined page at a first moment is obtained, and second element attribute information of the target page element at a second moment is obtained, wherein the second element attribute information and the first element attribute information are element attribute information of a same predetermined element attribute, and a difference between the second moment and the first moment is less than a predetermined duration. In accordance with a determination that a numerical difference between the first attribute information and the second attribute information is greater than a predetermined numerical difference threshold, it is determined that abnormal presentation is present for the target page element. By adopting the solution, the attribute information of the same predetermined element attribute at different moments is obtained for the page element presented in the viewport, and if the element attribute information changes greatly in a relatively short time, abnormal conditions such as a jumping change of the presentation of the page element can be determined, and the accuracy of page element detection is improved.

In some embodiments, after determining that the presentation abnormality is present for the target page element, the method may further comprise: recording abnormality information, wherein the abnormality information may comprise, for example, an element identifier of the target page element, the first moment, the second moment, the first attribute information, the second attribute information, or the numerical difference between the first attribute information and the second attribute information, and the like. This facilitates subsequent induction and analysis of the plurality of pieces of abnormality information to generate an abnormality report and output the abnormality report, so that the related developer optimizes the predetermined page related rendering policy or code based on the abnormality report.

In some embodiments, obtaining the first element attribute information of the target page element presented in the viewport of the predetermined page at the first moment comprises: determining an exposure page element in an exposure element set corresponding to the first moment as the target page element presented in the viewport of the predetermined page at the first moment, wherein the exposure element set is a dynamically updated set of page elements presented in the viewport of the predetermined page; and obtaining the first element attribute information of the target page element at the first moment. Therefore, the exposure element set is maintained in a dynamic updating manner, so that the page element presented at each moment in the viewport can be accurately determined. At the first moment, the target page element can be quickly and accurately determined by determining the exposure page element currently comprised in the exposure element set.

For example, the exposure page element is a page element presented in the viewport of the predetermined page, and the exposure page element in the exposure element set may be stored in an element identifier form. The dynamic updating manner of the exposure element set is not limited. For example, the page element presented in the viewport may be detected in real time to determine the element identifier of the exposure page element, and the element identifier may be stored in the exposure element set.

In some embodiments, the predetermined page corresponds to a predetermined element set comprising a presentable page element of the predetermined page, the method further comprises: in response to detecting that an exposure event of a target presentable page element is triggered, adding the target presentable page element to the exposure element set, wherein the target presentable page element is a presentable page element in the predetermined element set; and in response to detecting that an exposure cancellation event of a target exposure page element is triggered, removing the target exposure page element from the exposure element set, wherein the target exposure page element is an exposure page element in the exposure element set. Therefore, by detecting the triggering of the exposure event and the exposure cancellation event, the exposure element set can be updated accurately in time.

For example, the exposure event and the exposure cancellation (dis-exposure) event may be specifically Document Object Model (DOM) events. The exposure event of each presentable page element may be detected in real time to implement a global exposure detection mechanism. For example, when a rendering process of a predetermined page starts or during the rendering process, an exposure event is bound for each presentable page element, and the binding may specifically be setting detection of the exposure event of the presentable page element through a rendering layer. When it is detected that an exposure event of a certain presentable page element is triggered, the presentable page element is marked as a target presentable page element, and added to the exposure element set to form an exposure page element in the exposure element set. When it is detected that an exposure cancellation event of a certain exposure page element is triggered, the exposure page element is marked as a target exposure page element, and removed from the exposure element set, such that the exposure element set is updated.

In some embodiments, the predetermined element attribute comprises an element position and/or an element size, wherein the predetermined page corresponds to a predetermined element set comprising presentable page elements of the predetermined page. The element position is a coordinate in a predetermined coordinate system corresponding to the predetermined element set, and a coordinate range of the predetermined coordinate system is greater than a coordinate range of the viewport in the predetermined coordinate system. The method further comprises: computing a first numerical difference between a first element position in the first attribute information and a second element position in the second attribute information; and/or computing a second numerical difference between a first element size in the first attribute information and a second element size in the second attribute information; and determining the numerical difference between the first attribute information and the second attribute information according to the first numerical difference and/or the second numerical difference. Therefore, whether there is an abnormal situation such as a jumping change of the presentation the target page element in the viewport can be determined according to whether the element position and/or the element size changes greatly.

For example, the predetermined coordinate system corresponding to the predetermined element set may be a Cartesian coordinate system, and each presentable page element in the predetermined element set may correspond to a coordinate in the predetermined coordinate system as an element position of the presentable page element to which the predetermined element set belongs. The number of presentable page elements in the predetermined element set is usually much greater than the number of page elements that can be presented at a same moment in the viewport, and thus the coordinate range of the predetermined coordinate system is greater than the coordinate range of the viewport in the predetermined coordinate system.

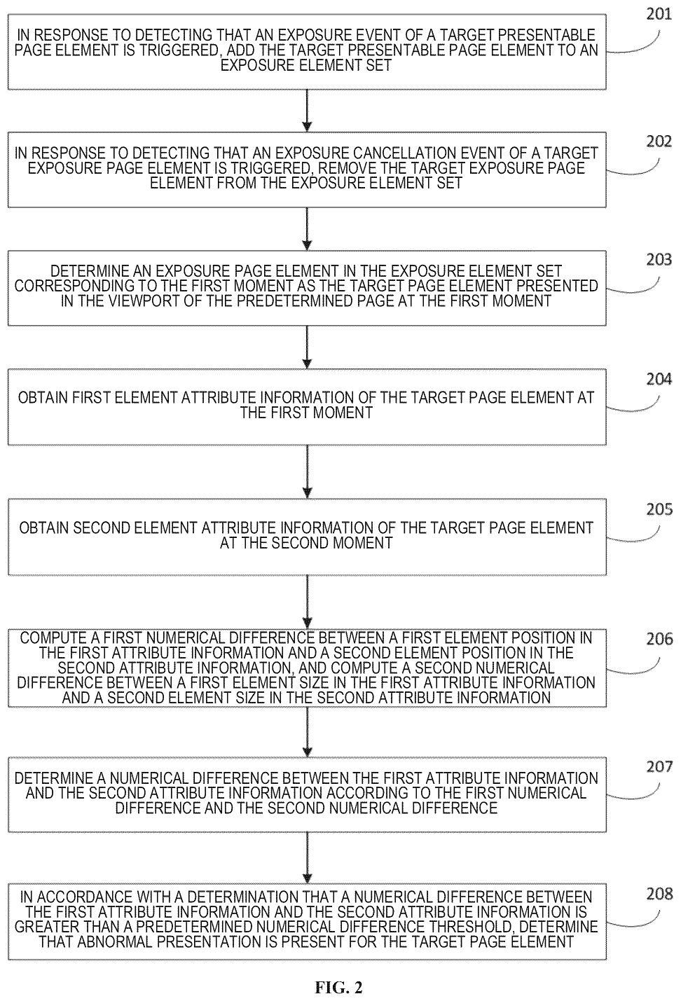

FIG. 2 is a schematic flowchart of a method of page element detection according to embodiments of the present disclosure. The embodiments of the present disclosure are optimized based on various optional solutions in the above embodiments. Specifically, the method includes the following steps.

Step 201: in response to detection of an exposure event of a target presentable page element being triggered, the target presentable page element is added to the exposure element set.

The target presentable page element is a presentable page element in the predetermined element set. For example, when the predetermined page starts to be rendered, the exposure element set is empty.

Step 202: in response to detection of an exposure cancellation event of a target exposure page element being triggered, the target exposure page element is removed from the exposure element set.

The target exposure page element is an exposure page element in the exposure element set.

Step 203: an exposure page element in an exposure element set corresponding to the first moment is determined as the target page element presented in the viewport of the predetermined page at the first moment.

For example, the exposure element set is a dynamically updated set of page elements presented in the viewport of the predetermined page. If the first element attribute information of the target page element corresponding to each moment (that is, each moment may be considered as the first moment) needs to be obtained and recorded in real time, the target page element may be determined according to the latest exposure element set in real time. That is, the update time of the exposure element set may not be recorded. If it is necessary to determine the first moment according to the trigger moment of the predetermined event after detection of the predetermined event being triggered, the correspondence between the update time of the exposure element set and the exposure element set may be recorded (both the target exposable page element added in the exposure element set or the target exposure page element removed from the exposure element set may be regarded as one update, and the addition time or the removal time is the corresponding update time). That is, different update times may correspond to different exposure element sets. The corresponding target update time (for example, the latest update time before the first moment or may be the same as the first moment) is determined according to the determined first moment, and the exposure page element in the exposure element set corresponding to the target update time is determined as the target page element presented in the viewport of the predetermined page at the first moment.

Step 204: first element attribute information of the target page element at the first moment is obtained.

For example, the element attribute information of the target page element may be obtained through a predetermined function in the predetermined interface. The predetermined interface may be, for example, a SelectorQuery application programming interface (API), and the predetermined function may be, for example, a boundingClientRect function. Through the predetermined function, the position information and the size information of the page element may be obtained, for example, the coordinate values x and y representing the position information, and the width value w and the height value h representing the size information.

Optionally, a Map data structure may be constructed. In the Map, an element identifier is a key, and element attribute information (such as a boundingClientRect object) is a value, so that the Map may be used to dynamically track position information and size information of each page element, to facilitate subsequent comparison and analysis. Therefore, the accuracy and real-time performance of obtaining the position information and the size information are improved, and the position and size information of the page elements are efficiently managed and updated through the Map data structure.

For example, obtaining the first element attribute information of the target page element at the first moment specifically includes: obtaining a first Map corresponding to the first moment, and determining first element attribute information of the target page element according to a first target value corresponding to a first target key in the first Map, where the first target key is an element identifier of the target page element.

Step 205: second element attribute information of the target page element at the second moment is obtained.

For example, obtaining the first element attribute information of the target page element at the second moment specifically includes: obtaining a second Map corresponding to the second moment, and determining second element attribute information of the target page element according to a second target value corresponding to a second target key in the second Map, where the second target key is the element identifier of the target page element.

Step 206: a first numerical difference between a first element position in the first attribute information and a second element position in the second attribute information is computed, and a second numerical difference between a first element size in the first attribute information and a second element size in the second attribute information is computed.

Optionally, there are a plurality of target page elements. This step may comprise: for each target page element, computing a first numerical sub-difference between a first element position in the first attribute information and a second element position in the second attribute information of the current target page element; and computing a sum of the first numerical sub-differences respectively corresponding to the plurality of target page elements, to obtain the first numerical difference; and computing, for each target page element, a second numerical sub-difference between a first element size in the first attribute information and a second element size in the second attribute information of the current target page element; and computing a sum of the second numerical sub-differences respectively corresponding to the plurality of target page elements to obtain the second numerical difference.

For example, the number of target page elements is n, i represents the ith target page element, a first element position is denoted as l₁, a second element position is denoted as l₂, a first numerical difference is denoted as Sum₁, and the first numerical difference may be determined by the following formula:

$${Sum}_{1} = {\sum }_{i = 1}^{n} ( {l}_{2} - {l}_{1} )$$

The first element size is denoted as s₁, the second element size is denoted as s₂, the second value difference is denoted as Sum₂, and the second numerical difference may be determined by the following formula:

$${Sum}_{2} = {\sum }_{i = 1}^{n} ( {s}_{2} - {s}_{1} )$$

Step 207: a numerical difference between the first attribute information and the second attribute information is determined according to the first numerical difference and the second numerical difference.

For example, the numerical differences between the first attribute information and the second attribute information comprises the first numerical difference and the second numerical difference.

Step 208: in accordance with a determination that the numerical difference(s) between the first attribute information and the second attribute information is greater than a predetermined numerical difference threshold, it is determined that abnormal presentation is present for the target page element.

For example, a predetermined numerical difference threshold may be separately set for the element position and the element size, and may be respectively denoted as the first predetermined numerical difference threshold and the second predetermined numerical difference threshold. It should be noted that, in a process of browsing a page by a user, for example, the user inputting a sliding operation, the element position of the target page element also changes, but the change amplitude is relatively small in two relatively short moments. The element position change caused by the normal browsing situation may be excluded by reasonably setting a first predetermined numerical difference threshold. For example, the first predetermined numerical difference threshold is a predetermined multiple of the viewport height, and the predetermined multiple is, for example, greater than 2.

If the first numerical difference is greater than the first predetermined numerical difference threshold and/or the second numerical difference is greater than the second predetermined numerical difference threshold, it is determined that the abnormal presentation is present for the target page element.

In the method of page element detection provided by the embodiments of the present disclosure, for the target page element presented in the viewport, position information and size information corresponding to the target page element at two similar moments are obtained. In the case where a plurality of target page elements are present in the viewport, an accumulation value of the position information change and an accumulation value of the size information change of the plurality of target page elements are computed and compared with the corresponding predetermined numerical difference thresholds. If at least one of the accumulation value of the position information change or the accumulation value of the size information change is greater than the corresponding predetermined numerical value difference threshold value, it may be determined that abnormal conditions such as the jumping change are present for the presentation of the whole predetermined page, thereby the jumping change abnormity of the rendering sequence can be efficiently detected and analyzed. For the e-commerce scene, when the commodity card is presented in the predetermined page, if the jumping change is present for the sequence, size or position in the rendering process, the user experience can be seriously damaged, and the negative effect on the e-commerce platform is caused. By adopting the above solutions, the jumping change abnormality of the commodity card can be efficiently and accurately detected, thereby facilitating the related developers to conveniently trace and analyze the abnormality, rapidly optimize the page rendering strategy, improve the user experience and the page performance, and further improve the client performance of the e-commerce platform.

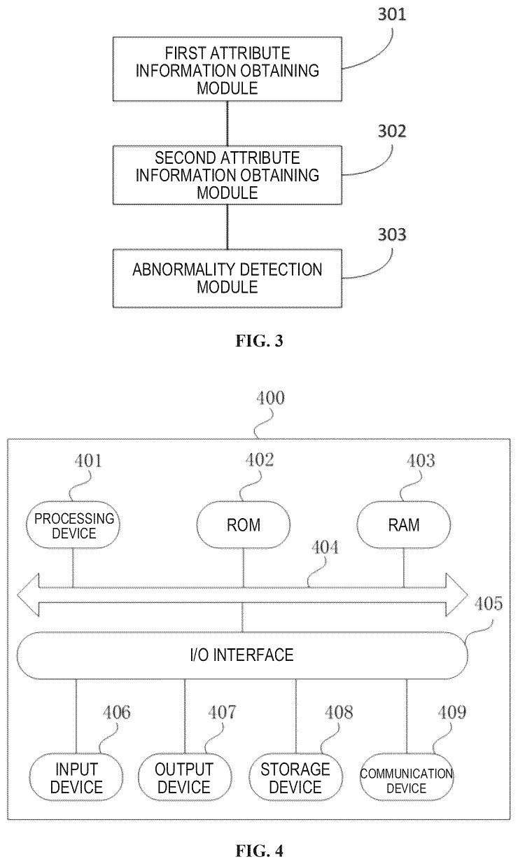

FIG. 3 is a schematic structural diagram of an apparatus of page element detection according to embodiments of the present disclosure. As illustrated in FIG. 3, the apparatus includes: a first attribute information obtaining module 301 configured to obtain first element attribute information of a target page element presented in a viewport of a predetermined page at a first moment; a second attribute information obtaining module 302 configured to obtain second element attribute information of the target page element at a second moment, wherein the second element attribute information and the first element attribute information are element attribute information of a same predetermined element attribute, and a difference between the second moment and the first moment is less than a predetermined duration; and an abnormality detection module 303 configured to in accordance with a determination that a numerical difference between the first attribute information and the second attribute information is greater than a predetermined numerical difference threshold, determine that abnormal presentation is present for the target page element.

According to the apparatus of page element detection provided by the embodiments of the present disclosure, for the page element presented in the viewport, the attribute information of the same predetermined element attribute at different moments is obtained, and if the element attribute information changes greatly in a relatively short time, it may be determined that abnormal conditions such as the jumping change are present for of presentation of the page element, thus the accuracy of page element detection is improved.

Optionally, the first attribute information obtaining module comprises: a target page element determining unit, configured to determine an exposure page element in an exposure element set corresponding to the first moment as the target page element presented in the viewport of the predetermined page at the first moment, wherein the exposure element set is a dynamically updated set of page elements presented in the viewport of the predetermined page; and a first attribute information obtaining unit, configured to obtain the first element attribute information of the target page element at the first moment.

Optionally, the predetermined page corresponds to a predetermined element set comprising a presentable page element of the predetermined page; and the apparatus further comprises: an element adding module, configured to in response to detect that an exposure event of a target presentable page element is triggered, add the target presentable page element to the exposure element set, wherein the target presentable page element is a presentable page element in the predetermined element set; and an element removal module, configured to in response to detect that an exposure cancellation event of a target exposure page element is triggered, remove the target exposure page element from the exposure element set, wherein the target exposure page element is an exposure page element in the exposure element set.

Optionally, the predetermined element attribute comprises an element position and/or an element size, wherein the predetermined page corresponds to a predetermined element set, and the predetermined element set comprises a presentable page element of the predetermined page. The element position is a coordinate in a predetermined coordinate system corresponding to the predetermined element set, and a coordinate range of the predetermined coordinate system is greater than a coordinate range of the viewport in the predetermined coordinate system.

The apparatus further comprises: a numerical difference computing module, configured to compute a first numerical difference between a first element position in the first attribute information and a second element position in the second attribute information; and/or compute a second numerical difference between a first element size in the first attribute information and a second element size in the second attribute information; and a numerical difference determining module, configured to determine the numerical difference between the first attribute information and the second attribute information according to the first numerical difference and/or the second numerical difference.

Optionally, a plurality of the target page elements are present, wherein computing the first numerical difference between the first element position in the first attribute information and the second element position in the second attribute information comprises: for each target page element, computing a first numerical sub-difference between a first element position in the first attribute information and a second element position in the second attribute information of the current target page element; and computing a sum of the first numerical sub-differences respectively corresponding to the plurality of target page elements to obtain the first numerical difference; wherein computing the second numerical difference between the first element size in the first attribute information and the second element size in the second attribute information comprises: for each target page element, computing a second numerical sub-difference between a first element size in the first attribute information and a second element size in the second attribute information of the current target page element; and computing a sum of the second numerical sub-differences respectively corresponding to the plurality of target page elements, to obtain a second numerical difference.

Optionally, the first moment is a moment before a predetermined event is triggered, and the second moment is a moment after the predetermined event is triggered. The predetermined event comprises at least one of: a page refresh event, an event of invoking a page data request interface, or a page interaction event.

The apparatus of page element detection provided by the embodiments of the present disclosure may perform the method of page element detection provided by any embodiment of the present disclosure, and has corresponding functional modules to execute the method and beneficial effects.

It should be noted that the units and modules included in the foregoing apparatus are only divided according to the function logic, but are not limited to the foregoing division, as long as the corresponding functions can be implemented; in addition, the specific names of the functional units are merely for ease of distinguishing, and are not intended to limit the protection scope of the embodiments of the present disclosure.

FIG. 4 is a schematic structural diagram of an electronic device according to embodiments of the present disclosure. With reference to FIG. 4, FIG. 4 illustrates a schematic structural diagram of an electronic device (such as the terminal device or server in FIG. 4) suitable for implementing the embodiments of the present disclosure. The terminal device in the embodiments of the present disclosure may include, but is not limited to, a mobile terminal such as a mobile phone, a notebook computer, a digital broadcast receiver, a PDA (personal digital assistant), a PAD (tablet computer), a PMP (portable multimedia player), an in-vehicle terminal (for example, an in-vehicle navigation terminal), and a fixed terminal such as a digital TV, a desktop computer, or the like. The electronic device shown in FIG. 4 is merely an example, and should not impose any limitation on the functions and scope of use of the embodiments of the present disclosure.

As shown in FIG. 4, the electronic device 400 may include a processing device (for example, a central processing unit, a graphics processor, etc.) 401, which may perform various appropriate actions and processing according to a program stored in a read-only memory (ROM) 402 or a program loaded into a random access memory (RAM) 403 from a storage device 408. In the RAM 403, various programs and data required by the operation of the electronic device 400 are also stored. The processing device 401, the ROM 402, and the RAM 403 are connected to each other through a bus 404. An input/output (I/O) interface 405 is also connected to the bus 404.

Generally, the following devices may be connected to the I/O interface 405: an input device 406 including, for example, a touch screen, a touchpad, a keyboard, a mouse, a camera, a microphone, an accelerometer, a gyroscope, etc.; an output device 407 including, for example, a liquid crystal display (LCD), a speaker, a vibrator, etc.; a storage device 408 including, for example, a magnetic tape, a hard disk, etc.; and a communication device 409. The communication device 409 may allow the electronic device 400 to communicate wirelessly or wired with other devices to exchange data. While FIG. 4 shows an electronic device 400 having various devices, it should be understood that it is not required to implement or have all illustrated devices. More or fewer devices may alternatively be implemented or provided.

In particular, according to embodiments of the present disclosure, the process described above with reference to the flowchart may be implemented as a computer software program. For example, embodiments of the present disclosure include a computer program product comprising a computer program embodied on a non-transitory computer readable medium, the computer program comprising program code for performing the method shown in the flowchart. In such embodiments, the computer program may be downloaded and installed from the network through the communication device 409, or installed from the storage device 408, or from the ROM 402. When the computer program is executed by the processing device 401, the foregoing functions defined in the method of the embodiments of the present disclosure are performed.

The names of messages or information exchanged between multiple devices in embodiments of the present disclosure are for illustrative purposes only and are not intended to limit the scope of such messages or information.

The electronic device provided by the embodiments of the present disclosure and the page element detection method provided in the foregoing embodiments belong to the same inventive concept, and technical details not described in detail in this embodiment may refer to the foregoing embodiments, and this embodiment has the same beneficial effects as the foregoing embodiments.

Embodiments of the present disclosure provides a computer storage medium having a computer program stored thereon, the program, when executed by a processor, implements the method of page element detection provided in the foregoing embodiments.

Embodiments of the present disclosure provides a computer program product, including a computer program, where when the program is executed by a processor, the method of page element detection provided in the foregoing embodiments is implemented.

It should be noted that the computer-readable medium described above may be a computer readable signal medium, a computer readable storage medium, or any combination of the foregoing two. The computer-readable storage medium may be, for example, but not limited to, an electrical, magnetic, optical, electromagnetic, infrared, or semiconductor system, device, or device, or any combination thereof. More specific examples of computer-readable storage media may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the foregoing. In the present disclosure, a computer-readable storage medium may be any tangible medium containing or storing a program that may be used by or in connection with an instruction execution system, apparatus, or device. In the present disclosure, a computer readable signal medium may include a data signal propagated in baseband or as part of a carrier, where the computer readable program code is carried. Such propagated data signals may take a variety of forms including, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted with any suitable medium, including, but not limited to: wires, optical cables, RF (radio frequency), and the like, or any suitable combination of the foregoing.

The computer-readable medium described above may be included in the electronic device; or may be separately present without being assembled into the electronic device.

The computer readable medium carries one or more programs, and when the one or more programs are executed by the electronic device, the electronic device is caused to: obtain first element attribute information of a target page element presented in a viewport of a predetermined page at a first moment; obtain second element attribute information of the target page element at a second moment, wherein the second element attribute information and the first element attribute information are element attribute information of a same predetermined element attribute, and a difference between the second moment and the first moment is less than a predetermined duration; and in accordance with a determination that a numerical difference between the first attribute information and the second attribute information is greater than a predetermined numerical difference threshold, determine that abnormal presentation is present for the target page element.

Computer program code for performing the operations of the present disclosure may be written in one or more programming languages, including, but not limited to, object oriented programming languages such as Java, Smalltalk, C++, and conventional procedural programming languages, such as the “C” language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, including a local area network (LAN) or a wide area network (WAN), or may be connected to an external computer (e.g., connected through the Internet using an Internet service provider).

The flowcharts and block diagrams in the figures illustrate architecture, functionality, and operation of possible implementations of systems, methods, and computer program products according to various embodiments of the present disclosure. In this regard, each block in the flowchart or block diagram may represent a module, program segment, or portion of code that includes one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. For example, the first attribute information obtaining module may be further described as “obtaining the first element attribute information of the target page element presented in the viewport of the predetermined page at the first moment”.

The functions described above may be performed, at least in part, by one or more hardware logic components. For example, without limitation, exemplary types of hardware logic components that may be used include: field programmable gate arrays (FPGAs), application specific integrated circuits (ASICs), application specific standard products (ASSPs), system-on-a-chip (SOCs), complex programmable logic devices (CPLDs), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage media may include electrical connections based on one or more lines, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing.

The above description is merely an illustration of the preferred embodiments of the present disclosure and the principles of the application. It should be understood by those skilled in the art that the disclosure in the present disclosure is not limited to the technical solutions of the specific combination of the above technical features, and should also cover other technical solutions formed by any combination of the above technical features or their equivalent features without departing from the above disclosed concept. For example, the above features are the technical solutions formed by mutually replacing technical features disclosed in the present disclosure (but not limited to).

Further, while operations are depicted in a particular order, this should not be understood to require that these operations be performed in the particular order shown or in sequential order. In certain circumstances, multitasking and parallel processing may be advantageous. Likewise, while several specific implementation details are included in the discussion above, these should not be construed as limiting the scope of the present disclosure. Certain features described in the context of separate embodiments may also be implemented in combination in a single embodiment. Conversely, the various features described in the context of a single embodiment may also be implemented in multiple embodiments either individually or in any suitable sub-combination.

Although the present subject matter has been described in language specific to structural features and/or methodological acts, it is to be understood that the subject matter defined in the appended claims is not necessarily limited to the specific features or acts described above. Rather, the specific features and acts described above are merely exemplary forms of implementing the claims.

What is claimed:

1. A method of page element detection, comprising:
obtaining first element attribute information of a target page element presented in a viewport of a predetermined page at a first moment;
obtaining second element attribute information of the target page element at a second moment, wherein the second element attribute information and the first element attribute information are element attribute information of a same predetermined element attribute, and a difference between the second moment and the first moment is less than a predetermined duration; and
in accordance with a determination that a numerical difference between the first attribute information and the second attribute information is greater than a predetermined numerical difference threshold, determining that abnormal presentation is present for the target page element.

2. The method of claim 1, wherein obtaining the first element attribute information of the target page element presented in the viewport of the predetermined page at the first moment comprises:
determining an exposure page element in an exposure element set corresponding to the first moment as the target page element presented in the viewport of the predetermined page at the first moment, wherein the exposure element set is a dynamically updated set of page elements presented in the viewport of the predetermined page; and
obtaining the first element attribute information of the target page element at the first moment.

3. The method of claim 2, wherein the predetermined page corresponds to a predetermined element set comprising presentable page elements of the predetermined page, and the method further comprises:
in response to detecting that an exposure event of a target presentable page element is triggered, adding the target presentable page element to the exposure element set, wherein the target presentable page element is a presentable page element in the predetermined element set; and
in response to detecting that an exposure cancellation event of a target exposure page element is triggered, removing the target exposure page element from the exposure element set, wherein the target exposure page element is an exposure page element in the exposure element set.

4. The method of claim 1, wherein the predetermined element attribute comprises an element position and/or an element size, wherein the predetermined page corresponds to a predetermined element set comprising presentable page elements of the predetermined page, the element position is a coordinate in a predetermined coordinate system corresponding to the predetermined element set, and a coordinate range of the predetermined coordinate system is greater than a coordinate range of the viewport in the predetermined coordinate system, and
wherein the method further comprises:
computing a first numerical difference between a first element position in the first attribute information and a second element position in the second attribute information; and/or computing a second numerical difference between a first element size in the first attribute information and a second element size in the second attribute information; and
determining the numerical difference between the first attribute information and the second attribute information according to the first numerical difference and/or the second numerical difference.

5. The method according to claim 4, wherein the target page element is one of a plurality of target page elements,
wherein computing the first numerical difference between the first element position in the first attribute information and the second element position in the second attribute information comprises:
computing, for each target page element, a first numerical sub-difference between a first element position in the first attribute information and a second element position in the second attribute information of the current target page element; and
computing a sum of the first numerical sub-differences corresponding to the plurality of target page elements respectively to obtain the first numerical difference, and
wherein computing the second numerical difference between the first element size in the first attribute information and the second element size in the second attribute information comprises:
computing, for each target page element, a second numerical sub-difference between a first element size in the first attribute information and a second element size in the second attribute information of the current target page element; and
computing a sum of the second numerical sub-differences corresponding to the plurality of target page elements respectively to obtain the second numerical difference.

6. The method of claim 1, wherein the first moment is a moment before a predetermined event is triggered, the second moment is a moment after the predetermined event is triggered, and the predetermined event comprises at least one of a page refresh event, an event of invoking a page data request interface, or a page interaction event.

7. An electronic device, comprising:
one or more processors; and
a storage device storing one or more programs,
the one or more programs, when executed by the one or more processors, causing the one or more processors to perform acts comprising:
obtaining first element attribute information of a target page element presented in a viewport of a predetermined page at a first moment;
obtaining second element attribute information of the target page element at a second moment, wherein the second element attribute information and the first element attribute information are element attribute information of a same predetermined element attribute, and a difference between the second moment and the first moment is less than a predetermined duration; and
in accordance with a determination that a numerical difference between the first attribute information and the second attribute information is greater than a predetermined numerical difference threshold, determining that abnormal presentation is present for the target page element.

8. The electronic device of claim 7, wherein obtaining the first element attribute information of the target page element presented in the viewport of the predetermined page at the first moment comprises:
determining an exposure page element in an exposure element set corresponding to the first moment as the target page element presented in the viewport of the predetermined page at the first moment, wherein the exposure element set is a dynamically updated set of page elements presented in the viewport of the predetermined page; and
obtaining the first element attribute information of the target page element at the first moment.

9. The electronic device of claim 8, wherein the predetermined page corresponds to a predetermined element set comprising presentable page elements of the predetermined page, and the acts further comprise:
in response to detecting that an exposure event of a target presentable page element is triggered, adding the target presentable page element to the exposure element set, wherein the target presentable page element is a presentable page element in the predetermined element set; and
in response to detecting that an exposure cancellation event of a target exposure page element is triggered, removing the target exposure page element from the exposure element set, wherein the target exposure page element is an exposure page element in the exposure element set.

10. The electronic device of claim 7, wherein the predetermined element attribute comprises an element position and/or an element size, wherein the predetermined page corresponds to a predetermined element set comprising presentable page elements of the predetermined page, the element position is a coordinate in a predetermined coordinate system corresponding to the predetermined element set, and a coordinate range of the predetermined coordinate system is greater than a coordinate range of the viewport in the predetermined coordinate system, and
wherein the acts further comprise:
computing a first numerical difference between a first element position in the first attribute information and a second element position in the second attribute information; and/or computing a second numerical difference between a first element size in the first attribute information and a second element size in the second attribute information; and
determining the numerical difference between the first attribute information and the second attribute information according to the first numerical difference and/or the second numerical difference.

11. The electronic device according to claim 10, wherein the target page element is one of a plurality of target page elements,
wherein computing the first numerical difference between the first element position in the first attribute information and the second element position in the second attribute information comprises:
computing, for each target page element, a first numerical sub-difference between a first element position in the first attribute information and a second element position in the second attribute information of the current target page element; and
computing a sum of the first numerical sub-differences corresponding to the plurality of target page elements respectively to obtain the first numerical difference, and
wherein computing the second numerical difference between the first element size in the first attribute information and the second element size in the second attribute information comprises:
computing, for each target page element, a second numerical sub-difference between a first element size in the first attribute information and a second element size in the second attribute information of the current target page element; and
computing a sum of the second numerical sub-differences corresponding to the plurality of target page elements respectively to obtain the second numerical difference.

12. The electronic device of claim 7, wherein the first moment is a moment before a predetermined event is triggered, the second moment is a moment after the predetermined event is triggered, and the predetermined event comprises at least one of a page refresh event, an event of invoking a page data request interface, or a page interaction event.

13. A non-transitory storage medium comprising computer-executable instructions, wherein the computer-executable instructions, when executed by a computer processor, perform a method of page element detection comprising:
obtaining first element attribute information of a target page element presented in a viewport of a predetermined page at a first moment;
obtaining second element attribute information of the target page element at a second moment, wherein the second element attribute information and the first element attribute information are element attribute information of a same predetermined element attribute, and a difference between the second moment and the first moment is less than a predetermined duration; and
in accordance with a determination that a numerical difference between the first attribute information and the second attribute information is greater than a predetermined numerical difference threshold, determining that abnormal presentation is present for the target page element.

14. The non-transitory storage medium of claim 13, wherein obtaining the first element attribute information of the target page element presented in the viewport of the predetermined page at the first moment comprises:
determining an exposure page element in an exposure element set corresponding to the first moment as the target page element presented in the viewport of the predetermined page at the first moment, wherein the exposure element set is a dynamically updated set of page elements presented in the viewport of the predetermined page; and
obtaining the first element attribute information of the target page element at the first moment.

15. The non-transitory storage medium of claim 14, wherein the predetermined page corresponds to a predetermined element set comprising presentable page elements of the predetermined page, and the method further comprises:
in response to detecting that an exposure event of a target presentable page element is triggered, adding the target presentable page element to the exposure element set, wherein the target presentable page element is a presentable page element in the predetermined element set; and
in response to detecting that an exposure cancellation event of a target exposure page element is triggered, removing the target exposure page element from the exposure element set, wherein the target exposure page element is an exposure page element in the exposure element set.

16. The non-transitory storage medium of claim 13, wherein the predetermined element attribute comprises an element position and/or an element size, wherein the predetermined page corresponds to a predetermined element set comprising presentable page elements of the predetermined page, the element position is a coordinate in a predetermined coordinate system corresponding to the predetermined element set, and a coordinate range of the predetermined coordinate system is greater than a coordinate range of the viewport in the predetermined coordinate system.

17. The non-transitory storage medium of claim 16, wherein the method further comprises:
computing a first numerical difference between a first element position in the first attribute information and a second element position in the second attribute information; and/or computing a second numerical difference between a first element size in the first attribute information and a second element size in the second attribute information; and
determining the numerical difference between the first attribute information and the second attribute information according to the first numerical difference and/or the second numerical difference.

18. The non-transitory storage medium according to claim 16, wherein the target page element is one of a plurality of target page elements.

19. The non-transitory storage medium according to claim 18, wherein computing the first numerical difference between the first element position in the first attribute information and the second element position in the second attribute information comprises:
computing, for each target page element, a first numerical sub-difference between a first element position in the first attribute information and a second element position in the second attribute information of the current target page element; and
computing a sum of the first numerical sub-differences corresponding to the plurality of target page elements respectively to obtain the first numerical difference, and
wherein computing the second numerical difference between the first element size in the first attribute information and the second element size in the second attribute information comprises:
computing, for each target page element, a second numerical sub-difference between a first element size in the first attribute information and a second element size in the second attribute information of the current target page element; and
computing a sum of the second numerical sub-differences corresponding to the plurality of target page elements respectively to obtain the second numerical difference.

20. The non-transitory storage medium of claim 13, wherein the first moment is a moment before a predetermined event is triggered, the second moment is a moment after the predetermined event is triggered, and the predetermined event comprises at least one of a page refresh event, an event of invoking a page data request interface, or a page interaction event.
